(19) United States
(12) Patent Application Publication
(10) Pub. No.: US 2006/0101819 A1
(43) Pub. Date: May 18, 2006

(54) Method and system for influencing the quantity of exhaust gas recirculated in a pressure charged internal combustion engine

(76) Inventors: Norbert A. Schorn, Aachen (DE); Helmut M. Kindl, Aachen (DE); Uwe R. Spaeder, Aachen (DE); Rob Stalman, Selfkant (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 11/232,529

(22) Filed: Sep. 22, 2005

(30) Foreign Application Priority Data
Sep. 22, 2004 (EP) 04104581.6

(51) Int. Cl. F02D 23/00; F02B 33/44; F02M 25/07

(52) U.S. Cl. 60/602; 60/605.2; 123/568.12; 123/568.2

(57) ABSTRACT

The invention relates to a pressure charged internal combustion engine (1) having at least two cylinders (3), configured to form two groups (3′, 3″) each with a separate exhaust line (4′, 4″), and two exhaust-gas turbochargers connected in parallel (6, 7), a first turbine (6a) being arranged in the exhaust line (4′) of the first group (3′) and a second turbine (7a)) being arranged in the exhaust line (4″) of the second group (3 ″) and the compressors (6b, 7b) coupled to these turbines (6a, 7a) arranged in separate intake lines (2′, 2″), which converge to form an intake manifold (2) to supply the internal combustion engine (1) with fresh air. The invention relates to a method of influencing the quantity of exhaust gas recirculated by a pressure charged internal combustion engine (1). The pressure charged internal combustion engine is capable of achieving high exhaust gas recirculation rates and high boost pressures simultaneously.

### FIELD OF THE INVENTION

The invention relates to a method of influencing the quantity of exhaust gas recirculated by a pressure charged internal combustion engine in a pressure charged internal combustion engine having two turbochargers.

### BACKGROUND OF INVENTION

In recent years there has been a trend towards small, highly pressure charged engines, the pressure charging primarily being a method of boosting the power output, in which the air needed for the engine combustion process is compressed. The economic importance of these engines for the automobile manufacturing industry steadily continues to increase.

Pressure charging, meaning pressurizing the intake gases, is generally achieved by the use of an exhaust-gas turbocharger, in which a compressor and a turbine are arranged on the same shaft, the hot exhaust gas flow being delivered to the turbine, where it expands, releasing energy and causing the shaft to rotate. The energy which the exhaust gas flow delivers to the turbine and ultimately to the shaft is used to drive the compressor, likewise arranged on the shaft. The compressor delivers and compresses the charge air fed to it, thereby pressure charging the cylinders.

The advantage of the exhaust-gas turbocharger compared to mechanical superchargers, for example, is that no mechanical connection exists or is required for the transmission of power between the pressure charging device and the internal combustion engine. Whereas, a mechanical supercharger obtains all of the energy needed to drive it from the internal combustion engine, thereby reducing the power provided and adversely affecting efficiency. In contrast, the exhaust-gas turbocharger utilizes the exhaust gas energy of the hot exhaust gases.

Typical of the small, highly pressure charged engines is an internal combustion engine with exhaust gas turbocharging, in which the exhaust gas energy is used for compression of the combustion air, and which also has charge air cooling, which serves to cool the compressed combustion air before it enters the combustion chamber.

As already stated above, the use of exhaust-gas turbochargers has increased greatly in recent years, there being no foreseeable end to this trend. The reasons for this are complex and will be briefly outlined below.

The pressure charging serves primarily to boost the power of the internal combustion engine. The air needed for the combustion process is compressed, with the result that a larger mass of air can be delivered to each cylinder in each working cycle. This makes it possible to increase the fuel mass and hence the mean pressure pₘₑ. Pressure charging is a suitable means of boosting the power of an internal combustion engine for the same engine displacement, or of reducing the engine displacement for the same power output. In any event, pressure charging leads to an increase in the power per unit volume and to a more favorable power-to-mass ratio. Given identical vehicle boundary conditions therefore, the engine operates where the specific fuel consumption is lower when pressure charging is employed. The latter is also referred to as downsizing.

In the ongoing effort to develop internal combustion engines, pressure charging consequently assists in minimizing fuel consumption. It improves the efficiency of the internal combustion engine, in view of the limited fossil fuel resources, in particular the limited deposits of mineral oil available as raw material for the extraction of fuels for the operation of internal combustion engines.

Pressure charging can be purposely designed to obtain advantages in terms of efficiency and in exhaust emissions. For example, in the case of the diesel engine suitable pressure charging can serve to reduce the nitrogen oxide emissions without incurring any penalties in terms of efficiency. At the same time, there may be a beneficial effect on hydrocarbon emissions. The carbon dioxide emissions, which correlate directly with the fuel consumption, likewise diminish with falling fuel consumption. Pressure charging is therefore also suitable for reducing the pollutant emissions.

The design of the exhaust-gas turbocharger presents problems in that a discernible increase in the power output is sought in all engine speed ranges. In the state of the art, however, a pronounced loss of torque is observed once the engine speed drops below a specific number of revolutions. This effect is undesirable, since even in the lower engine speed range the driver expects a correspondingly high torque compared to a naturally aspirated engine of identical power output. The so-called turbo lag at low engine speeds, therefore, ranks as one of the most serious disadvantages of exhaust turbocharging.

Boost pressure ratio varies as a function of the turbine pressure ratio. If the engine speed of a diesel engine is reduced, for example, this leads to a smaller exhaust gas mass flow and hence to a smaller turbine pressure ratio. As a result, towards the lower engine speeds the boost pressure ratio also falls, which results in the loss of torque.

The fall in the boost pressure can be counteracted by a reduction of the turbine cross-section and the associated rise in the turbine pressure ratio, which, however, leads to disadvantages at high engine speeds.

In practice the correlations described often mean that the smallest possible exhaust-gas turbocharger, that is to say an exhaust-gas turbocharger with the smallest possible turbine cross-section is used. This ultimately counteracts the loss of torque only to a limited extent and the loss of torque is shifted further towards the lower engine speeds. There are, moreover, limits to this approach, that is to say the reduction of the turbine cross-section, since the desired pressure charging and power increase are supposed to be possible without restriction and to the desired extent even at high engine speeds.

In the state of the art, various measures are taken in an effort to improve the torque characteristic of a pressure charged internal combustion engine.

For example, by a small turbine cross-section and with simultaneous exhaust gas pressure relief, the exhaust gas pressure relief being controlled by the boost pressure or by the exhaust gas pressure. Such a turbine is also referred to as a wastegate turbine. Once the exhaust gas mass flow exceeds a critical value, a proportion of the exhaust gas flow bypasses the turbine by a bypass line as part of the so-called exhaust gas pressure relief. This method, however, as already described above, has the disadvantage that the pressure charging performance is inadequate at higher engine speeds.

It is in principle, also, possible to design the turbine with a small turbine cross-section in conjunction with charge air relief, this variant seldom being used owing to the energy disadvantages of charge air relief, that is to say the adverse effect on the overall efficiency, and the fact that existing compressors can reach their delivery limit and are therefore no longer able to supply the desired output.

In the case of diesel engines, such a small turbine cross-section and the simultaneous limiting of the boost pressure can be achieved by reducing the fuel mass at high engine speeds. However, this does not fully exploit the scope for boosting power by means of exhaust gas turbocharging.

The exhaust-gas turbocharger, however, can also be tuned to high engine speeds and designed with a large turbine cross-section. In this case, the intake system is then configured so that a dynamic pressure charging occurs due to wave phenomena at low engine speeds. The disadvantages here are the high build costs and the sluggish behavior in response to engine speed changes.

A turbine having a variable turbine geometry allows the turbine geometry and/or the effective turbine cross-section to be adjusted to the prevailing operating point of the internal combustion engine, so that the turbine geometry can be controlled for low and high engine speeds and for low and high loads.

The torque characteristic of a pressure-charged internal combustion engine can also be improved by compound pressure charging. In this case multiple turbochargers connected in parallel and having correspondingly small turbine cross-sections are actuated as the load increases.

Multiple turbochargers connected in parallel are suited to improving the torque characteristic even when, as in the case of an internal combustion engine of the generic type, they are configured in such a way that the cylinders of the internal combustion engine are divided into two groups of cylinders each having a separate exhaust line, and an exhaust-gas turbocharger is coupled to each of the two exhaust lines or each group of cylinders. The turbine of the first exhaust-gas turbocharger is here arranged in the exhaust line of the first group of cylinders, while the turbine of the second exhaust-gas turbocharger is arranged in the exhaust line of the second group of cylinders. Both turbines are therefore driven not by a common aggregate exhaust gas flow, each of the two turbines, isolated from the other turbine, instead are being driven by means of a separate exhaust gas partial flow from the corresponding group of cylinders.

The compressors of the exhaust-gas turbochargers are arranged, corresponding to the arrangement of the two turbines, in two separate intake lines, these intake lines being united to form an intake manifold.

Arranging the exhaust-gas turbochargers and turbines in parallel in this way allows the exhaust-gas turbochargers to be of smaller dimensions and allows the turbines to be designed for smaller exhaust gas flows.

In addition, to the smaller overall space required, two exhaust-gas turbochargers connected in parallel also offer further advantages. The response of such a pressure charged internal combustion engine is improved compared to a comparable internal combustion engine having only one exhaust-gas turbocharger. The reason for this is that the two smaller exhaust-gas turbochargers are less sluggish than one larger exhaust-gas turbocharger and the rotor can be accelerated and retarded more rapidly, the exhaust lines in most cases being more compact so that better use is made of the surge effects.

The formation of nitrogen oxides requires not only excess air but also high temperatures. A concept for the reduction of nitrogen oxide emissions involves the development of combustion processes or methods having low combustion temperatures.

The recirculation of combustion gases from the exhaust line into the intake line is an appropriate method, in which the nitrogen oxide emissions can be significantly reduced as the exhaust gas recirculation rate increases. The exhaust gas recirculation rate x_{EGR} is determined as follows:
x_{EGR}=m_{EGR}/(m_{EGR}+m_{fresh air})
where m_{EGR} is the mass of recirculated exhaust gas and m_{fresh air} is the fresh air or combustion air delivered, where necessary, fed and compressed by a compressor.

Exhaust gas recirculation also reduces emissions of unburned hydrocarbons in the partial load range.

To achieve a significant reduction in the nitrogen oxide emissions, high exhaust gas recirculation rates are necessary, x_{EGR}=60% to 70%.

This results, however, in a conflict when operating an internal combustion engine with exhaust gas turbocharging and the simultaneous use of exhaust gas recirculation, since the recirculated exhaust gas is drawn from the exhaust line upstream of the turbine. This conflict can be readily illustrated by reference to a singe-stage pressure charged internal combustion engine having an exhaust-gas turbocharger.

In the event of an increase in the exhaust gas recirculation rate there is a simultaneous decrease in the residual exhaust gas flow delivered to the turbine. The smaller exhaust gas mass flow through the turbine leads to a lower turbine pressure ratio. With a falling turbine pressure ratio the boost pressure ratio likewise diminishes, which results in a smaller compressor mass flow. In addition to the falling boost pressure, other problems can arise in the operation of the compressor with regard to the pumping limit of the compressor.

The increase in exhaust gas recirculation and the simultaneous fall in the boost pressure and compressor flow lead to a richer cylinder fresh charge (less fresh air) in the combustion chamber. This leads to increased soot formation, especially during acceleration, because the inertia of the rotor of the exhaust-gas turbocharger the quantity of fuel often increases more rapidly than the fresh air fed to the cylinders.

For this reason, pressure charging concepts are needed, which will ensure sufficiently high boost pressures with simultaneously high exhaust gas recirculation rates, especially in the partial load range. The conflict highlighted between exhaust gas recirculation and pressure charging is exacerbated by the fact that the recirculation of exhaust gas from the exhaust line into the intake line requires a pressure differential. i.e., a pressure gradient from the exhaust side to the intake side. To obtain the required high exhaust gas recirculation rates, a large pressure gradient is moreover necessary. This requires a boost pressure which is lower than the exhaust gas back-pressure in the exhaust line used for the exhaust gas recirculation, which is at odds with the requirement for a high boost pressure outlined above.

### SUMMARY OF THE INVENTION

According to the present invention, a pressure charged internal combustion engine having at least two cylinders, which are configured in such a way that they form two groups each comprising at least one cylinder and both groups of cylinders are each equipped with a separate exhaust line is disclosed. The engine has two exhaust-gas turbochargers connected in parallel, a first turbine of a first exhaust-gas turbocharger being arranged in the exhaust line of the first group of cylinders and a second turbine of a second exhaust-gas turbocharger being arranged in the exhaust line of the second group of cylinders and the compressors coupled to these turbines being arranged in separate intake lines, which downstream of the compressors converge to form an intake manifold and which serve to supply the internal combustion engine with fresh air or fresh mixture. In the context of the present invention the term internal combustion engine includes both diesel engines and spark-ignition engines.

The present invention overcomes the known disadvantages inherent in the state of the art and which is, in particular, capable of achieving simultaneously high exhaust gas recirculation rates and high boost pressures, particularly in the partial load range.

Another advantage of the present invention is to set forth a method of influencing the quantity of exhaust gas recirculated by a pressure charged internal combustion engine.

A pressure charged engine according to an aspect of the present invention has at least two cylinders, which are configured in such a way that they form two groups each comprising at least one cylinder and both groups of cylinders are each equipped with a separate exhaust line. The engine also has two exhaust-gas turbochargers connected in parallel, a first turbine of a first exhaust-gas turbocharger being arranged in the exhaust line of the first group of cylinders and a second turbine of a second exhaust-gas turbocharger being arranged in the exhaust line of the second group of cylinders and the compressors coupled to these turbines being arranged in separate intake lines, which downstream of the compressors converge to form an intake manifold and which serve to supply the internal combustion engine with fresh air or fresh mixture. A first line is provided for the exhaust gas recirculation, which upstream of the first turbine branches off from the first exhaust line coupled to this first turbine and opens into the intake manifold. A device is provided which is capable of influencing the exhaust gas back-pressure in this first exhaust line.

The internal combustion engine, according to the invention, is equipped with two exhaust-gas turbochargers connected in parallel, the turbines of which are arranged in separate exhaust lines. At least one of the two separate exhaust lines is equipped with an exhaust gas recirculation system, the invention providing for allowing the exhaust gas back-pressure in the first exhaust line used for exhaust gas recirculation to be increased or reduced.

In this way, it is possible to resolve the conflict, insoluble in the state of the art, between a high exhaust gas recirculation rate and a high boost pressure. While the first exhaust line is used to obtain a large recirculated exhaust gas flow, the first exhaust line is closed or the flow cross-section of this exhaust line is reduced. The turbine or the corresponding compressor arranged in the second exhaust line together with the compressor arranged in the first intake line delivers the desired and necessary boost pressure unaffected by the exhaust gas recirculation.

It therefore does not matter that at high exhaust gas recirculation rates the turbine arranged in the first exhaust line no longer receives a flow of hot exhaust gas or that only a small exhaust gas flow is provided for this first turbine, and that the first compressor coupled to the first turbine consequently delivers and compresses no or scarcely any combustion air, since the second exhaust-gas turbocharger ensures that an adequate boost pressure is built up on the intake side even under operating conditions with extensive exhaust gas recirculation.

Advantageous embodiments of the internal combustion engine include those in which the exhaust gas back-pressure is adjusted by a shut-off element, preferably a valve, provided in the first exhaust line. The shut-off element serves for preferably continuously variable adjustment of the flow cross-section of the first exhaust line, such reduction of the flow cross-section leading to the desired increase in the exhaust gas back-pressure. The increase in the exhaust gas back-pressure also has an influence on the exhaust gas recirculation rate. In principle, the shut-off element is provided downstream of the point where the first line for the exhaust gas recirculation branches off.

Both those embodiments of the internal combustion engine in which the first exhaust line can be largely closed by a shut-off element to obtain maximum exhaust gas back-pressures, and those in which this exhaust line is fully open, are of practical relevance.

The shut-off element allows the exhaust gas flow of the first group of cylinders to be divided into two exhaust gas partial flows, that is, into an exhaust gas partial flow which is led through the first line for the exhaust gas recirculation, and an exhaust gas partial flow which is led through the first turbine. This allows an influence to be exerted on the exhaust gas recirculation rate.

Advantageous embodiments of the internal combustion engine include those in which the shut-off element is electrically, hydraulically, pneumatically, mechanically or magnetically controllable, preferably by the engine management system of the internal combustion engine.

Advantageous embodiments of the internal combustion engine include those in which the shut-off element for influencing the exhaust gas back-pressure is arranged in the exhaust line downstream of the first turbine. With the shut-off element not fully closed this embodiment allows the exhaust gas flow to first flow through the turbine before it passes the shut-off element, which represents a restriction or a flow resistance for the exhaust gas flow. In this way of the exhaust gas heat content and the exhaust gas pressure are partially recovered in the turbine.

Advantageous embodiments of the internal combustion engine include those in which the first turbine has a variable turbine geometry. A variable turbine geometry increases the flexibility of the pressure charging. It permits a continuously variable adjustment of the turbine geometry to the prevailing operating point of the internal combustion engine. In contrast to a turbine of fixed geometry, it is necessary to compromise in the design of the turbine to achieve a more or less satisfactory pressure charging in all engine speed ranges. In particular, it is possible to dispense not only with charge air pressure relief and its energy disadvantages, but also with exhaust gas pressure relief, as undertaken in the case of wastegate turbines.

Advantageous embodiments of the internal combustion engine, given a variable turbine geometry of the first turbine, include those in which the first turbine influences the exhaust gas back-pressure, an increase in the exhaust gas back-pressure being achievable through adjustment of the turbine towards a reduced cross-section, which can be done through rotation of the blades. The adjustable geometry is, in this embodiment, used to increase the exhaust gas back-pressure in the manner proposed according to the invention.

Additional components, in particular a separate shut-off element, are not required where the existing turbine of the first exhaust-gas turbocharger is used for influencing the pressure. The separate shut-off element also obviates the need for a separate control of this element and the control unit required for this purpose.

Advantageous embodiments of the internal combustion engine, particularly in this context, include those in which the first turbine is smaller than the second turbine. If the first turbine has a variable geometry and this turbine is smaller than the second turbine, i.e., designed for small exhaust gas quantities, high exhaust gas back-pressures can be generated in the first exhaust line. To be able to operate the first turbine even at high loads and/or with larger exhaust gas mass flows, a pressure relief line must be provided, via which an increasing proportion of the exhaust gases is blown off as the quantity of exhaust gas increases. Thus, the turbine must be designed as a so-called wastegate turbine, an embodiment which will be further discussed below.

Advantageous embodiments of the internal combustion engine, however, also include those in which the first turbine has a fixed, non-variable turbine geometry. In contrast to the variable turbine geometry (VTG) previously discussed, the design principle here dispenses with any control. Overall, therefore, this embodiment has particular cost advantages.

Advantageous embodiments of the internal combustion engine also include those in which the first turbine takes the form of a wastegate turbine. So-called wastegate turbines have a bypass line bypassing the turbine for the purpose of exhaust gas relief. Such a turbine can therefore be purposely designed for small exhaust gas flows, which significantly improves the quality of the pressure charging in the partial load range. As the exhaust gas flow increases a greater proportion of the exhaust gas is led past the turbine via the bypass line. For controlling the exhaust gas relief a shut-off element is provided in the bypass line. A wastegate turbine is more economical than a turbine with variable turbine geometry. Moreover the control is simpler and therefore likewise more economical than in the case of a variable turbine geometry.

Advantageous embodiments of the internal combustion engine include those in which the first compressor coupled to the first turbine has a variable compressor geometry. As already stated in connection with the VTG turbine, a variable geometry increases the quality and flexibility of the pressure charging owing to the facility for a continuously variable adjustment of the geometry to the prevailing operating point of the internal combustion engine.

In particular, when only a very small exhaust gas mass flow is being led through the first turbine, a variable compressor geometry (VCG) proves advantageous, since through adjustment of the blades the pumping limit of the compressor in the compressor characteristic curve can be shifted towards small compressor flows, thus avoiding any working of the compressor beyond the pumping limit. This embodiment is particularly advantageous where the turbine of the first exhaust-gas turbocharger has a variable turbine geometry and the compressor geometry is being continuously adjusted to the turbine geometry.

Advantageous embodiments of the internal combustion engine include those in which the first compressor coupled to the first turbine has a fixed, non-variable compressor geometry. For the same reasons as fixed geometry turbines, that is, their simpler design construction, fixed geometry compressors also have cost advantages.

Advantageous embodiments of the internal combustion engine include those in which the first compressor coupled to the first turbine is equipped with a bypass line is, which branches off from the first intake line downstream of the first compressor and opens into the first intake line preferably upstream of the first compressor. For controlling the quantity of fresh air blown off, a shut-off element is provided in the bypass line. The compressor which can be bypassed by means of a bypass line, in particular, represents an alternative to a variable compressor geometry.

Advantageous embodiments of the internal combustion engine include those in which an intercooler is arranged in the intake manifold downstream of the compressors. The intercooler lowers the air temperature and thereby increases the density of the air, with the result that the cooler also contributes to better filling of the combustion chamber with air.

Advantageous embodiments of the internal combustion engine include those in which the first line for the exhaust gas recirculation opens into the intake manifold downstream of the intercooler. Thus, the exhaust gas flow is not led through the intercooler and consequently cannot foul this cooler due to deposits of pollutants, in particular soot particles and oil contained in the exhaust gas flow.

Advantageous embodiments of the internal combustion engine include those in which an additional cooler is provided in the first line for the exhaust gas recirculation. This additional cooler reduces the temperature in the hot exhaust gas flow and thereby increases the density of the exhaust gases. The temperature of the fresh cylinder charge, which results when the fresh air mixes with the recirculated exhaust gases, is thereby consequently further reduced, so that the additional cooler also contributes to better filling of the combustion chambers with fresh mixture.

Advantageous embodiments of the internal combustion engine include those in which a shut-off element is provided in the first line for the exhaust gas recirculation. This shut-off element serves to control the exhaust gas recirculation rate. Unlike other ways of influencing the exhaust gas back-pressure, this shut-off element is capable of directly controlling and also fully preventing the exhaust gas recirculation.

Advantageous embodiments of the internal combustion engine include those in which a second line for the exhaust gas recirculation is provided, which upstream of the second turbine branches off from the second exhaust line coupled to this second turbine and opens into the intake manifold. This embodiment affords advantages particularly in the case of high exhaust gas recirculation rates.

In the internal combustion engine, according to the invention, the exhaust gas flow is divided into two exhaust gas partial flows. If, as in the embodiments hitherto described, only one exhaust line is used for the exhaust gas recirculation, EGR rates of more than 50% (x_{EGR}>0.5) can be achieved only with difficulty, since half of the exhaust gases are already unavailable for recirculation. Higher EGR rates can only be obtained through a reduction of the compressor mass flow of the second compressor, i.e., through a reduction of the boost pressure, which is not the intention.

It is therefore advantageous to equip the second exhaust line with an additional second line for the exhaust gas recirculation. The greater part of the exhaust gas recirculation is preferably still concentrated on the first exhaust line, in which the exhaust gas back-pressure is purposely increased. An asymmetrical control of the two exhaust gas lines is, in any case, desirable and is already provided by influencing the exhaust gas back-pressure in the first exhaust line. The second line should preferably only be used in achieving very high EGR rates, i.e., in the case of EGR rates of more than 50%. In this way, high boost pressures and high EGR rates can be achieved.

Advantageous embodiments of the internal combustion engine include those in which the second line for the exhaust gas recirculation opens into the intake manifold downstream of the intercooler.

Also advantageous are embodiments of the internal combustion engine, in which an additional cooler is provided in the second line for the exhaust gas recirculation.

The advantages of the latter two aforementioned embodiments have already been outlined in connection with the first line for the exhaust gas recirculation, for which reason reference should here be made to the corresponding descriptions.

Advantageous embodiments of the internal combustion engine include those in which a shut-off element is provided in the second line for the exhaust gas recirculation. This shut-off element serves, together with the shut-off element arranged in the first line and the device for influencing the exhaust gas back-pressure in the first exhaust line, for adjusting EGR rate.

The preferred design constructions for the turbine and the compressor of the second exhaust-gas turbocharger will be described below. The advantages of the individual design constructions, that is the variable geometry, the fixed geometry and the wastegate design have already been discussed in detail in connection with the first exhaust-gas turbocharger and the first turbine and the first compressor, for which reason reference will here be made to the corresponding descriptions, to avoid repetition.

Advantageous embodiments of the internal combustion engine include those in which the second turbine has a variable turbine geometry. In particular, this increases the quality and flexibility of the pressure charging. The geometry can be adjusted to the exhaust gas mass flow through adjustment of the rotor blades.

Advantageous embodiments of the internal combustion engine include those in which the second turbine has a fixed, non-variable turbine geometry. This provides an economical pressure charging concept.

Advantageous embodiments of the internal combustion engine include those in which the second turbine takes the form of a wastegate turbine. This provides an economical pressure charging concept and at the same time allows the turbine to be designed for small exhaust gas mass flows, i.e., in the partial load range, which is of particular interest with regard to the relevant tests for determining the pollutant emissions.

Advantageous embodiments of the internal combustion engine include those in which the second compressor coupled to the second turbine has a variable compressor geometry. As already mentioned above, the variable geometry affords advantages particularly with regard to the pumping limit of the compressor by shifting this pumping limit. High boost pressures can be generated even with a small fresh air mass flow.

Advantageous embodiments of the internal combustion engine include those in which the second compressor coupled to the second turbine has a fixed, non-variable compressor geometry. Primary considerations here are the cost advantages and the simplified engine management of the entire internal combustion engine.

Advantageous embodiments of the internal combustion engine include those in which the second compressor coupled to the second turbine is equipped with a bypass line, which branches off from the second intake line downstream of the second compressor and opens into the second intake line preferably upstream of the second compressor. The compressor which can be bypassed by means of a bypass line in particular represents an alternative to a variable compressor geometry.

Advantageous embodiments of the internal combustion engine include those in which a shut-off element is provided in the first intake line downstream of the first compressors coupled to the first turbine. This shut-off element serves to isolate the first compressor from the rest of the intake system. This serves to prevent the second compressor discharging into the first compressor. This is a risk, for example, where the first exhaust line is used to achieve high EGR rates, the first compressor delivers virtually no combustion air and the second compressor is used, possibly exclusively, to generate the necessary boost pressure and to provide the necessary air mass. In the process a pressure gradient builds up between the compressors, the pressure upstream of the second compressor being greater than the pressure upstream of the first compressor.

A method of influencing the quantity of exhaust gas recirculated by a pressure charged internal combustion engine of the aforementioned type in disclosed in which, the quantity of recirculated exhaust gas is influenced by varying the exhaust gas back-pressure in the first exhaust line.

That which has been stated in connection with the internal combustion engine according to the invention also apples to the method according to the invention. By dividing the exhaust gas flow into two separate exhaust gas partial flows and influencing the exhaust gas back-pressure in one of the two exhaust lines, it is possible to achieve high EGR rates and high boost pressures simultaneously.

Although the arrangement of the two exhaust-gas turbochargers in the two exhaust lines may be symmetrical in such a way that, for example, both turbochargers are of the same overall size, the two exhaust lines and the two turbines provided in the exhaust lines are operated and controlled differently. While the first exhaust line or the first turbine is used largely with a view to exhaust gas recirculation, the second exhaust line or the second turbine primarily serves for generating a sufficiently high boost pressure.

Advantageous embodiments of the method include those in which the quantity of recirculated exhaust gas is increased by increasing the exhaust gas back-pressure in the first exhaust line.

In internal combustion engines in which the exhaust gas back-pressure is provided by a shut-off element, provided in the first exhaust line and is preferably arranged in the exhaust line downstream of the first turbine, advantageous embodiments of the method include those in which the gas back-pressure in the first exhaust line is increased through adjustment of the shut-off element towards the closed position.

In internal combustion engines, in which the first turbine has a variable turbine geometry, advantageous embodiments of the method include those in which the exhaust gas back-pressure in the first exhaust line is increased through adjustment of the variable turbine geometry of the first turbine towards the closed position, i.e., towards smaller turbine cross-sections.

Advantageous embodiments of the method include those in which the quantity of recirculated exhaust gas is reduced through a reduction of the exhaust gas back-pressure in the first exhaust line.

In internal combustion engines in which the exhaust gas back-pressure is adjusted via a shut-off element provided in the first exhaust line and is preferably arranged in the exhaust line downstream of the first turbine, advantageous embodiments of the method include those in which the exhaust gas back-pressure in the first exhaust line is reduced through adjustment of the shut-off element towards the open position.

In internal combustion engines, in which the first turbine has a variable turbine geometry, advantageous embodiments of the method include those in which the exhaust gas back-pressure in the first exhaust line is reduced through adjustment of the variable turbine geometry of the first turbine towards the open position, i.e., towards larger turbine cross-sections.

In internal combustion engines in which a second line for the exhaust gas recirculation is provided, which upstream of the second turbine branches off from the second exhaust line coupled to this second turbine and opens into the intake manifold, advantageous embodiments of the method include those in which both the first and the second line are used in obtain high exhaust gas recirculation rates.

### BRIEF DESCRIPTION OF THE FIGURES

The invention will be described in more detail below with reference to eight exemplary embodiments according to FIGS. 1 to 8, of which:

FIG. 1 is a schematic representation of a first embodiment of the internal combustion engine,

FIG. 2 is a schematic representation of a second embodiment of the internal combustion engine,

FIG. 3 is a schematic representation of a third embodiment of the internal combustion engine,

FIG. 4 is a schematic representation of a fourth embodiment of the internal combustion engine,

FIG. 5 is a schematic representation of a fifth embodiment of the internal combustion engine,

FIG. 6 is a schematic representation of a sixth embodiment of the internal combustion engine,

FIG. 7 is a schematic representation of a seventh embodiment of the internal combustion engine, and

FIG. 8 is a schematic representation of an eighth embodiment of the internal combustion engine.

### DETAILED DESCRIPTION

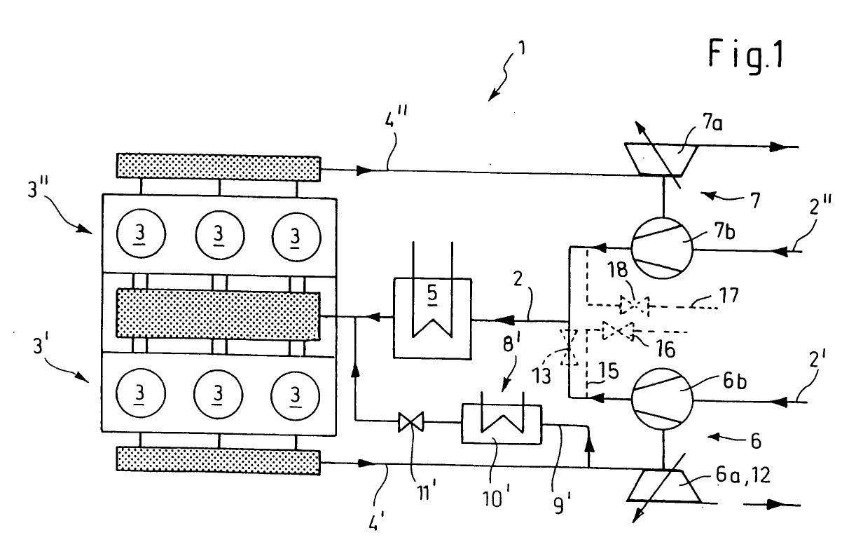

FIG. 1 shows a first embodiment of the pressure charged internal combustion engine 1, taking a six-cylinder V-engine as an example. The cylinders 3 of the internal combustion engine 1 are divided into two groups of cylinders 3′, 3″, which each have a separate exhaust line 4′, 4″, which is in each case not connected to the other exhaust line 4′, 4″.

Two exhaust-gas turbochargers 6, 7 connected in parallel are provided, the first turbine 6a of the first exhaust-gas turbocharger 6 being arranged in the first exhaust line 4′ of the first group of cylinders 3′ and the second turbine 7a of the second exhaust-gas turbocharger 7 being arranged in the second exhaust line 4″ of the second group of cylinders 3″.

The compressors 6b, 7b coupled to these turbines 6a, 7a are likewise arranged in separate intake lines 2′, 2″, which downstream of the compressors 6b, 7b converge to form an intake manifold 2 and which serve to supply the internal combustion engine 1 with fresh air or fresh mixture.

An intercooler 5 is arranged in the intake manifold 2 downstream of the compressor 6b, 7b. The intercooler 5 reduces the air temperature, thereby increasing the density of the air, so that it contributes to a better filling of the combustion chamber with air.

In the embodiment represented in the FIG. 1 both the turbine 6a of the first exhaust-gas turbocharger 6 and the turbine 7a of the second exhaust-gas turbocharger 7 have a variable turbine geometry (VTG—indicated by the arrow), which permits a continuously variable adjustment of the turbine geometry to the prevailing operating point of the internal combustion engine 1. In particular, this increases the quality and flexibility of the pressure charging. The geometry of the turbine 6b, 7b can be adjusted to the instantaneous exhaust gas mass flow through adjustment of the rotor blades.

The compressors 6b, 7b may have a fixed geometry or may likewise be designed with a variable geometry. A variable geometry is advantageous where the corresponding turbine 6a, 7a has a variable turbine geometry and the compressor geometry is continuously adjusted to the turbine geometry. A variable compressor geometry (VCG) proves advantageous particularly in the case of small exhaust gas mass flows through the turbine 6a, 7a with the associated a small compressor mass flows, since through adjustment of the blades the pumping limit of the compressor 6b, 7b in the compressor characteristic curve can be shifted towards small compressor flows, thereby avoiding any working of the compressor 6b, 7b beyond the pumping limit. In principle, the compressors 6a, 7a may also be equipped with a line for the charge air pressure relief, although for energy reasons this has some disadvantages.

The internal combustion engine 1 represented in FIG. 1 is equipped with an exhaust gas recirculation branch 8′. For this purpose a first line 9′ for the exhaust gas recirculation is provided, which upstream of the first turbine 6a branches off from the first exhaust line 4′ coupled to this first turbine 6a and opens into the intake manifold 2. In this case, the first line 9′ for the exhaust gas recirculation opens into the intake manifold 2 downstream of the intercooler 5. In this way, the exhaust gas flow is not led through the intercooler 5 and cannot foul this cooler 5.

An additional cooler 10′, which reduces the temperature of the hot exhaust gas flow, is provided in the first line 9′. A shut-off element 11 ′ for controlling the exhaust gas recirculation rate is likewise arranged in the first line 9′.

In the embodiment represented in FIG. 1, the first turbine 6a serves to influence the exhaust gas back-pressure. Through adjustment of the turbine 6a in such a way that the turbine cross-section is reduced, it is possible to increase the exhaust gas back-pressure. Influencing the exhaust gas back-pressure also has an effect on the pressure differential between the first exhaust line 4′ and the intake manifold 2, in which the boost pressure generated by compressors 6b, 7b prevails. The pressure differential is the motive force for the exhaust gas recirculation. A pressure gradient towards the intake manifold 2, i.e., an exhaust gas back-pressure which is greater than the boost pressure, is essential for the recirculation of hot exhaust gas.

To generate very high exhaust gas back-pressures, the first turbine 6a is very small or is designed for very small exhaust gas mass flows. To be able to operate the turbine 6a also at higher loads and/or with larger exhaust gas mass flows, a bypass line bypassing the turbine 6a (not shown) is desired.

A shut-off element 13 (indicated by a dot-and-dash line), which isolates the first compressor 6b from the rest of the intake system, may be provided in the first intake line 2′ downstream of the first compressor 6b. This serves to prevent the second compressor 7b discharging into the first compressor 6b. This is always a risk where the boost pressure of the first compressor 6b is less than the boost pressure of the second compressor 7b. For example, where the first exhaust line 4′ is virtually fully closed to achieve high EGR rates and the first compressor 6b delivers virtually no combustion air, since only a small exhaust gas mass flow, if any, is still flowing through the first turbine 6a. Then, it is almost exclusively the second compressor 7b that is used to generate the necessary boost pressure and to provide the necessary air mass. In the process, a pressure gradient builds up between the compressors 6b, 7b, the pressure upstream of the second compressor 7b being greater than the pressure upstream of the first compressor 6b.

Both the first compressor 6b and the second compressor 7b may be equipped with a bypass line 15, 17, which branches off from the intake line 2′, 2″ downstream of the compressor 6b, 7b and in which a shut-off element 16, 18 (represented by a dashed line) is arranged. These bypass lines serve for charge air pressure relief and hence for adjustment of the fresh air quantity and/or the boost pressure. They can basically open back into the intake line 2′, 2″ upstream of the compressor 6b, 7b, so that the fresh air blown off is only recirculated.

The turbines 6a, 7a may be equipped with pressure relief lines for blowing off the exhaust gas (not shown). This is advantageous particularly when the turbine 6a, 7a is designed for small loads and/or small exhaust gas mass flows and there is a desire that the turbine 6a, 7a can also be operated at higher loads, the larger exhaust gas mass flows which then occur causing an increasing quantity of exhaust gas to be blown off, bypassing the turbine 6a, 7a.

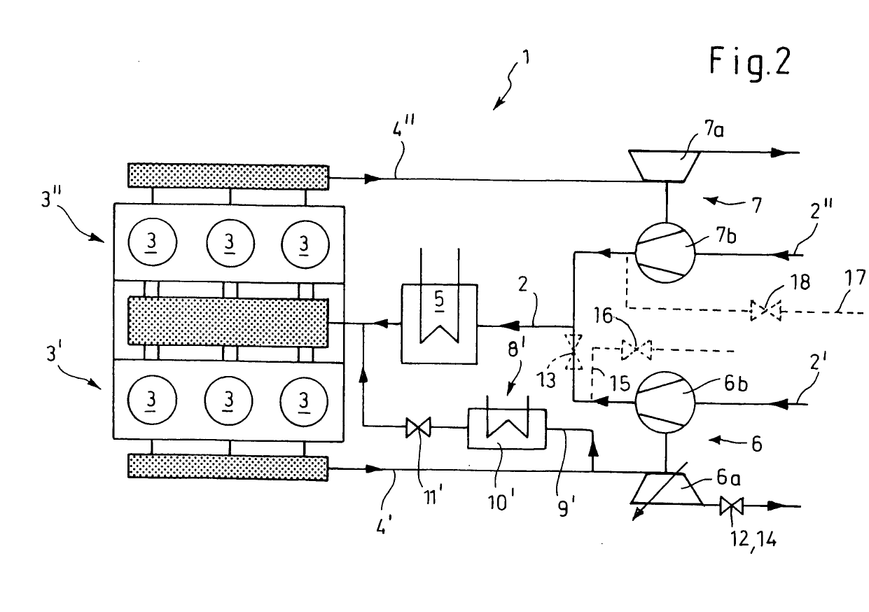

FIG. 2 shows a schematic representation of a second embodiment of the pressure charged internal combustion engine 1. Only those aspects distinguishing it from the embodiment represented in FIG. 1 will be discussed, for which reason reference will otherwise be made to FIG. 1. The same reference numerals have been used for the same components.

In contrast to the embodiment represented in FIG. 1, the second turbine 7a in the internal combustion engine 1 represented in FIG. 2 is designed with a fixed, that is to say a non-variable turbine geometry. In contrast to the embodiment of the turbine with variable turbine geometry (VTG) previously described, the design principle here dispenses with any control. Overall, this embodiment in particular has cost advantages.

A further difference compared to the embodiment according to FIG. 1 is that a separate shut-off element 14 is provided in the first exhaust line 2′ downstream of the first turbine 6a to influence the exhaust gas back-pressure. The shut-off element 14 serves for continuously variable adjustment of the flow cross-section of the first exhaust line 14. A reduction of the flow cross-section increases the exhaust gas back-pressure.

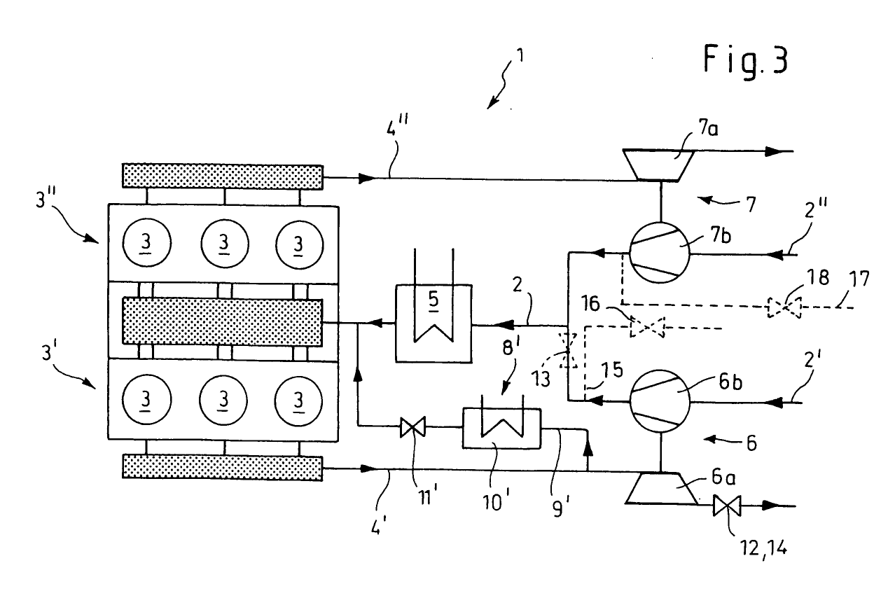

FIG. 3 shows a schematic representation of a third embodiment of the pressure charged internal combustion engine 1. Only those aspects distinguishing it from the embodiment represented in FIG. 2 will be discussed, for which reason reference will otherwise be made to FIG. 2. The same reference numerals have been used for the same components.

In contrast to the embodiment represented in FIG. 2 in the internal combustion engine 1 represented in FIG. 3 the first turbine 6a is likewise designed with a fixed, that is to say a non-variable turbine geometry, which again has cost advantages owing to the more economical type of turbine and to the absence of an expensive control.

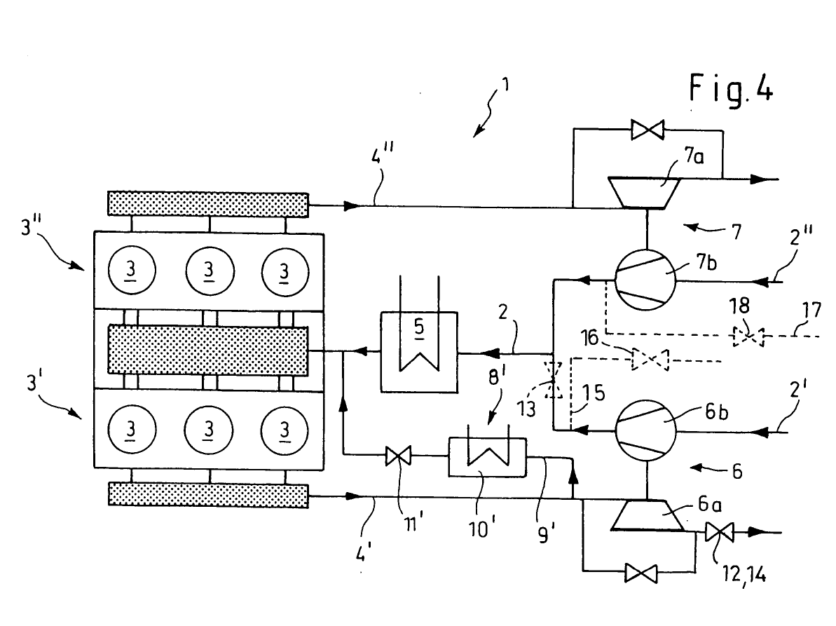

FIG. 4 shows a schematic representation of a fourth embodiment of the pressure charged internal combustion engine 1. Only those aspects distinguishing it from the embodiment represented in FIG. 3 will be discussed, for which reason reference will otherwise be made to FIG. 3. The same reference numerals have been used for the same components.

In contrast to the embodiment represented in FIG. 3 in the internal combustion engine 1 represented in FIG. 4 both turbines 6a, 7a are designed as wastegate turbines. For the purpose of exhaust gas relief the wastegate turbines 6a, 7a have a bypass line bypassing the turbine 6a, 7a, something which is a characteristic feature of this special type of turbine. The turbine 6a, 7a is designed for small exhaust gas flows, which significantly improves the quality of the pressure charging in the partial load range. As the exhaust gas flow increases a larger proportion of the exhaust gas is led past the turbine 6a, 7a via the bypass line. For controlling the exhaust gas relief a shut-off element is provided in the bypass line.

With regard to the design of an internal combustion engine 1 according to the invention it is essential that the bypass line of the first turbine 6a designed as a wastegate turbine should open into the exhaust line 4′ upstream of the shut-off element 14 arranged in the exhaust line 4′, so that the exhaust gas back-pressure can be influenced or increased solely by means of this shut-off element 14.

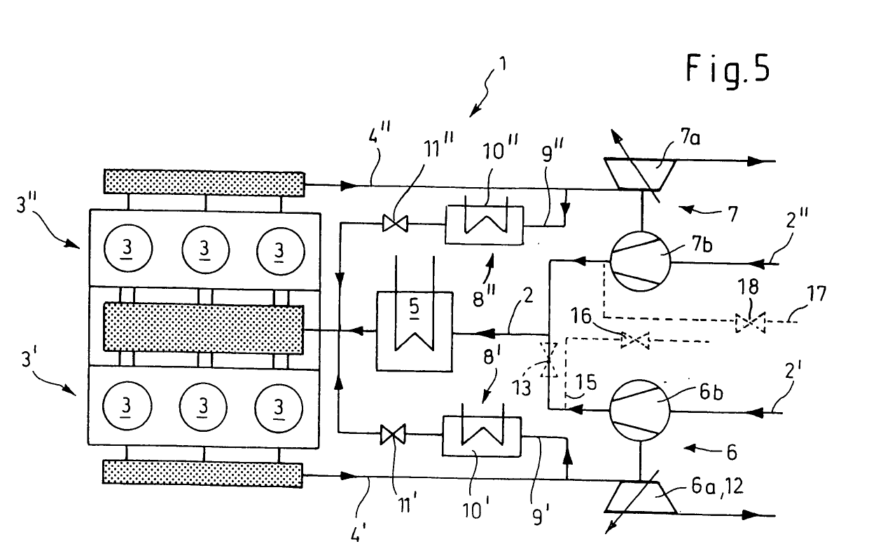

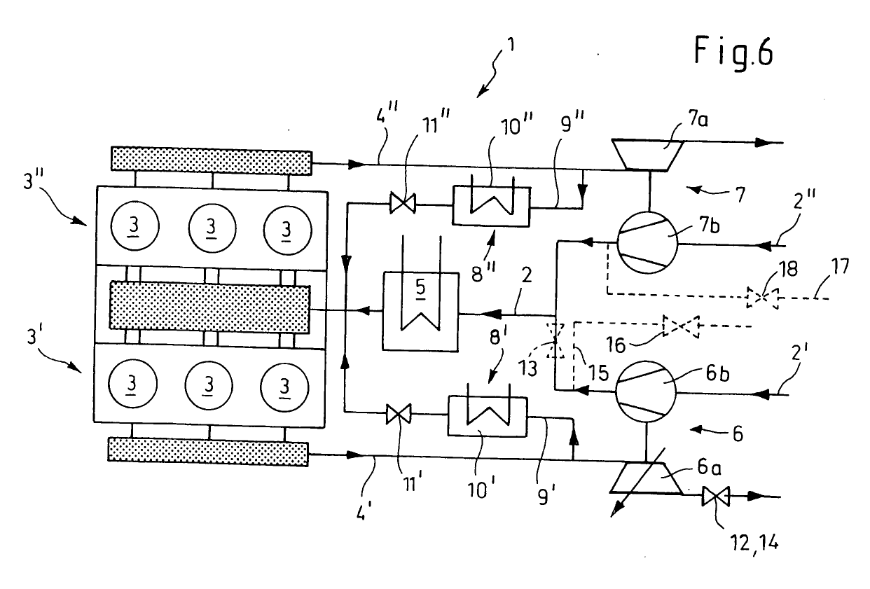

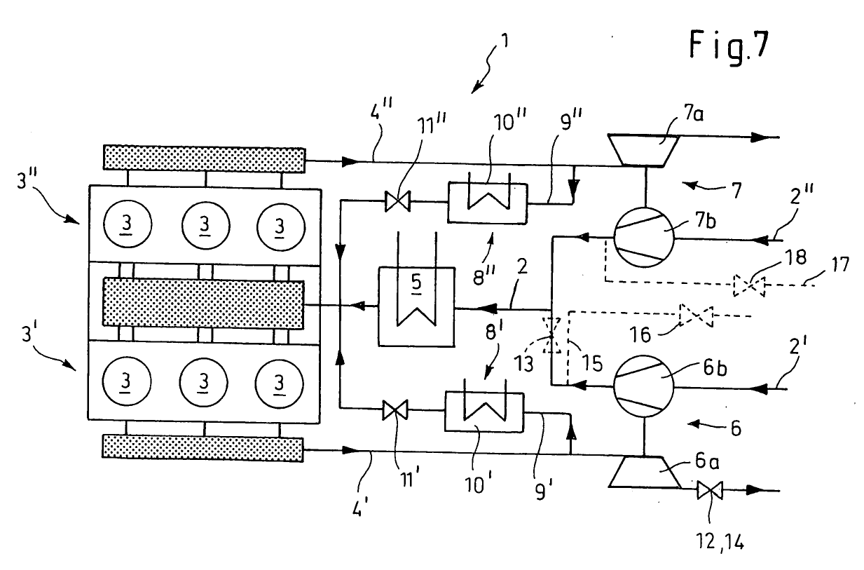

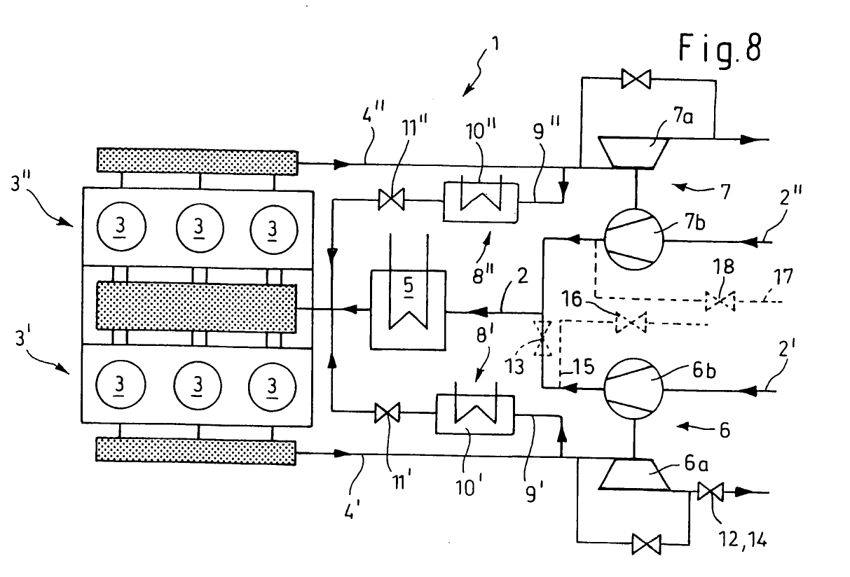

FIGS. 5 to 8 show a schematic representations of four further embodiments of the pressure charged internal combustion engine 1. Apart from one technical feature, which is described below, these embodiments correspond to the variants represented in FIGS. 1 to 4. Only this one feature distinguishing the embodiments will be discussed, for which reason reference will otherwise be made to FIGS. 1 to 4. The same reference numerals have been used for the same components.

In contrast to the embodiments represented in FIGS. 1 to 4, in the pressure charged internal combustion engine 1 represented in FIGS. 5 to 8 a second exhaust gas recirculation branch 8″ is provided. For this purpose a second line 9″ branches off from the second exhaust line 4″ upstream of the second turbine 7a and opens into the intake manifold 2 downstream of the intercooler 5.

As in the case of the first line 9′ for the exhaust gas recirculation an additional cooler 10″ and a shut-off element 11 ″ are also provided in the second line 9″ for the exhaust gas recirculation.

A second, additional exhaust gas recirculation branch 8″ is advantageous particularly with a view to high EGR rates, in particular for EGR rates of more than 50% (x_{EGR}>0.5). If only one exhaust line 4′ is used for the exhaust gas recirculation, EGR rates of more than 50% (x_{EGR}>0.5) can be achieved only at the expense of unacceptable disadvantages. The reason for this is that according to the invention there is no overall exhaust gas flow but rather two exhaust gas partial flows isolated from one another. Consequently, where only one exhaust gas recirculation branch 8′ is used, as shown in FIGS. 1 to 4, half of the exhaust gases, that is to say the exhaust gases which are led through the second exhaust line 4″, are already unavailable for recirculation. Higher EGR rates can then only be obtained by a reduction of the compressor mass flow of the second compressor 7b, by a reduction of the boost pressure, or precisely that which is to be avoided.

In the preferred embodiment, therefore, the aim is for just a second exhaust gas recirculation branch 8″. The greater part of the exhaust gas recirculation is still concentrated on the first exhaust line 4′. An asymmetrical control of the two exhaust lines 4′, 4″ is desirable and is possible by influencing the exhaust gas back-pressure in the first exhaust line 4′. The second line 9″ and second exhaust gas recirculation 8″ branch is used in achieving very high EGR rates, i.e., greater than 50%. The second exhaust line 4″ primarily serves to achieve high boost pressures.

We claim:

1. A pressure charged internal combustion engine (1) having at least two cylinders (3), which are configured in such a way that they form two groups (3′, 3″), each comprising at least one cylinder (3) and both groups of cylinders (3′, 3″) are each equipped with a separate exhaust line (4′, 4″), and having two exhaust-gas turbochargers connected in parallel (6, 7), a first turbine (6a) of a first exhaust-gas turbocharger (6) being arranged in the exhaust line (4′) of the first group of cylinders (3′) and a second turbine (7a) of a second exhaust-gas turbocharger (7) being arranged in the exhaust line (4″) of the second group of cylinders (3″) and the compressors (6b, 7b) coupled to these turbines (6a, 7a) being arranged in separate intake lines (2′, 2″), which downstream of the compressors (6b, 7b) converge to form an intake manifold (2) and which serve to supply the internal combustion engine (1) with fresh air or fresh mixture, comprising:
a first line (9′) for the exhaust gas recirculation, wherein said first line branches off from the first exhaust line (4′) upstream of the first turbine (6a)) and opens into the intake manifold (2); and
a device adapted to influence the exhaust gas back-pressure in this first exhaust line (4′).

2. The pressure charged internal combustion engine (1) as claimed in claim 1 wherein said device to influence the exhaust gas back-pressure is a shut-off element (14), which is provided in the first exhaust line (4′).

3. The pressure charged internal combustion engine (1) as claimed in claim 2, wherein said shut-off element (14) for influencing the exhaust gas back-pressure is a valve arranged in the exhaust line (4′) downstream of the first turbine (6a).

4. The pressure charged internal combustion engine (1) as claimed in claim 1, wherein the first turbine (6a) has a variable turbine geometry.

5. The pressure charged internal combustion engine (1) as claimed in claim 4, wherein the first turbine (6a) influences the exhaust gas back-pressure, an increase in the exhaust gas back-pressure being achievable through adjustment of the turbine (6a) towards a reduction in the cross-section.

6. The pressure charged internal combustion engine (1) as claimed in claim 1, wherein the first turbine (6a) is smaller than the second turbine (7a).

7. The pressure charged internal combustion engine (1) as claimed in claim 1, wherein the first turbine (6a) has a fixed, non-variable turbine geometry.

8. The pressure charged internal combustion engine (1) as claimed in claim 1, wherein the first turbine (6a) is a wastegate turbine.

9. The pressure charged internal combustion engine (1) as claimed in claim 1, wherein the first compressor (6b) coupled to the first turbine (6a) has a variable compressor geometry.

10. The pressure charged internal combustion engine (1) as claimed in claim 1, wherein the first compressor (6b) coupled to the first turbine (6a) has a fixed, non-variable compressor geometry.

11. The pressure charged internal combustion engine (1) as claimed in claim 1, wherein the first compressor (6b) coupled to the first turbine (6a) is equipped with a first bypass line (15), which branches off from the first intake line (2′) downstream of the first compressor (6b).

12. The pressure charged internal combustion engine (1) as claimed claim 1, further comprising an intercooler (5) arranged in the intake manifold (2) downstream of the compressors (6b, 7b).

13. The pressure charged internal combustion engine (1) as claimed in claim 12, wherein the first line (9′) for the exhaust gas recirculation opens into the intake manifold (2) downstream of the intercooler (5).

14. The pressure charged internal combustion engine (1) as claimed in claim 1, further comprising: an additional cooler (10′) in the first line (9′) for the exhaust gas recirculation.

15. The pressure charged internal combustion engine (1) as claimed in claim 1, further comprising:
a shut-off element (11 ′) in the first line (9′) for the exhaust gas recirculation.

16. The pressure charged internal combustion engine (1) as claimed in claim 1, further comprising: a second line (9″) for the exhaust gas recirculation which branches off from the second exhaust line (4″) upstream of the second turbine (7a) and opens into the intake manifold (2).

17. The pressure charged internal combustion engine (1) as claimed in claim 16, wherein the second line (9″) for the exhaust gas recirculation opens into the intake manifold (2) downstream of the intercooler (5).

18. The pressure charged internal combustion engine (1) as claimed in claim 16, further comprising:
an additional cooler (10″) in the second line (9″) for the exhaust gas recirculation.

19. The pressure charged internal combustion engine (1) as claimed in claim 16, further comprising:
a shut-off element (11″) in the second line (9″) for the exhaust gas recirculation.

20. The pressure charged internal combustion engine (1) as claimed in claim 1, wherein the second turbine (7a) has a variable turbine geometry.

21. The pressure charged internal combustion engine (1) as claimed in claim 1, wherein the second turbine (7a) has a fixed, non-variable turbine geometry.

22. The pressure charged internal combustion engine (1) as claimed in claim 1, wherein the second turbine (7a) is a wastegate turbine.

23. The pressure charged internal combustion engine (1) as claimed in claim 1, wherein the second compressor (7b) coupled to the second turbine (7a) has a variable compressor geometry.

24. The pressure charged internal combustion engine (1) as claimed in claim 1, wherein the second compressor (7b) coupled to the second turbine (7a) has a fixed, non-variable compressor geometry.

25. The pressure charged internal combustion engine (1) as claimed in claim 1, wherein the second compressor (7b) coupled to the second turbine (7a) is equipped with a second bypass line (17), which branches off from the second intake line (2″) downstream of the second compressor (7b)).

26. The pressure charged internal combustion engine (1) as claimed in claim 1, further comprising:
a shut-off element (13) in the first intake line (2′) downstream of the first compressor (6b) coupled to the first turbine (6a).

27. A method of influencing the quantity of exhaust gas recirculated by a pressure charged internal combustion engine (1) having at least two cylinders (3), which are configured in such a way that they form two groups (3′, 3″), each comprising at least one cylinder (3) and both groups of cylinders (3′, 3″) are each equipped with a separate exhaust line (4′, 4″), and having two exhaust-gas turbochargers connected in parallel (6, 7), a first turbine (6a) of a first exhaust-gas turbocharger (6) being arranged in the exhaust line (4′) of the first group of cylinders (3′) and a second turbine (7a) of a second exhaust-gas turbocharger (7) being arranged in the exhaust line (4″) of the second group of cylinders (3″) and the compressors (6b, 7b) coupled to these turbines (6a, 7a) being arranged in separate intake lines (2′, 2″), which downstream of the compressors (6b, 7b) converge to form an intake manifold (2) and which serve to supply the internal combustion engine (1) with fresh air, comprising:
varying the exhaust gas back-pressure in the first exhaust line (2′).

28. The method as claimed in claim 27, wherein the quantity of recirculated exhaust gas is boosted by increasing the exhaust gas back-pressure in the first exhaust line (2′).

29. The method as claimed in claim 28 wherein said device to influence the exhaust gas back-pressure is a shut-off element (14), provided in the first exhaust line (4′) and the exhaust gas back-pressure in the first exhaust line (2′) is increased through adjustment of a shut-off element (14) towards the closed position.

30. The method as claimed in claim 28, wherein the first turbine (6a) has a variable turbine geometry and the exhaust gas back-pressure in the first exhaust line (2′) is increased through adjustment of the variable turbine geometry of the first turbine (6a) towards the closed position, that is to say towards smaller turbine cross-sections.

31. The method as claimed in claim 27, wherein the quantity of recirculated exhaust gas is reduced by reducing the exhaust gas back-pressure in the first exhaust line (2′).

32. The method as claimed in claim 31, wherein said device to influence the exhaust gas back-pressure is a shut-off element (14), provided in the first exhaust line (4′) and the exhaust gas back-pressure in the first exhaust line (2′) is reduced through adjustment of the shut-off element (14) towards the open position.

33. The method as claimed in claim 31, wherein the first turbine (6a) has a variable turbine geometry and the exhaust gas back-pressure in the first exhaust line (2′) is reduced through adjustment of the variable turbine geometry of the first turbine (6a) towards the open position, that is to say towards larger turbine cross-sections.
